(19) United States
(12) Patent Application Publication
(10) Pub. No.: US 2024/0001633 A1
(43) Pub. Date: Jan. 4, 2024

(54) MOLDS AND METHODS FOR PRODUCING SEMI-PRODUCT AND HUB ASSEMBLY

(71) Applicants: Hsiu-Fan YU, Taipei City (TW); Yuan-Cheng YU, Taipei City (TW)

(72) Inventors: Hsiu-Fan YU, Taipei City (TW); Yuan-Cheng YU, Taipei City (TW)

(21) Appl. No.: 18/345,901

(22) Filed: Jun. 30, 2023

(30) Foreign Application Priority Data
Jul. 4, 2022 (TW) 111124918

(51) Int. Cl. B29C 70/54; B29C 70/30

(52) U.S. Cl. CPC B29C 70/541; B29C 70/545; B29C 70/30; B29L 2031/32

(57) ABSTRACT

A mold includes first and second disks, and a spindle connecting centers of first and second disks. The first disk has first linear grooves extending radially from the center to outer periphery of the first disk. The second disk has second linear grooves that extend radially from the center to outer periphery of the second disk and are respectively aligned with first linear grooves. The spindle has first and second end portions that protrude from the first and second disks, respectively. Methods using the mold for producing a semi-product and a hub assembly are also disclosed.

### CROSS-REFERENCE TO RELATED APPLICATION

This application claims priority to Taiwanese Invention Patent Application No. 111124918, filed on Jul. 4, 2022.

### FIELD

The disclosure relates to production of a hub assembly, and more particularly to a method for producing a semi-product for making a hub assembly, a method for producing a hub assembly, and a mold.

### BACKGROUND

In recent years, there is a growing need for lightweight carriers such as wheelchairs and bicycles; and carbon fibers, having advantages such as light weight and high strength, are increasingly used to produce bicycle components.

A conventional method for making a carbon fiber wheel of a bicycle includes the following steps: disposing a plurality of prepreg cloths one by one into a mold that contains a wheel rim, spokes, and a hub; fixing them by bonding, and heating the resin of the prepreg cloths to cure. After curing and drying the resin, a wheel that includes a wheel rim and a hub assembly made of carbon fiber is formed. Although such conventional method can produce high strength and light weight wheel rims and hub assemblies, the manufacturing process is too tedious, resulting in a long manufacturing time. Moreover, such conventional method is hard to automate due to the requirement for fine adjustments to be made during the manufacturing process.

### SUMMARY

Therefore, an object of the disclosure is to provide a method for producing a semi-product for making a hub assembly that can alleviate at least one of the drawbacks of the prior art.

According to one aspect of the disclosure, a method for producing a semi-product for making a hub assembly is provided. The semi-product includes two spoke units, each of which has a spoke center part defining a bearing mounting hole for mounting a bearing, and a plurality of spokes radially extending from the spoke center part. The spoke center part has an annular groove for connecting a hub axle. The method includes the steps of:
(A) preparing a mold and a curable fabric material that is cord-like, the mold including a first disk, a second disk, and a spindle that connects the center of the first disk and the center of the second disk, the first disk having a plurality of first linear grooves, each of which extends radially from the center of the first disk to the outer periphery of the first disk, the second disk having a plurality of second linear grooves, each of which extends radially from the center of the second disk to the outer periphery of the second disk, and each of which is aligned with one of the first linear grooves, the spindle having a first end portion that protrudes from the first disk, and a second end portion that is located opposite to the first end portion and that protrudes from the second disk;
(B) disposing the curable fabric material on the first disk such that one end of the curable fabric material is connected to the first end portion of the spindle, such that the curable fabric material loops around the first end portion of the spindle, and such that the curable fabric material extends through one of the first linear grooves;
(C) disposing the curable fabric material on the second disk from the first disk such that the curable fabric material extends through one of the second linear grooves from the one of the first linear grooves, loops over the second end portion of the spindle, and further extends through another one of the second linear grooves which remains empty;
(D) disposing the curable fabric material such that the fabric material returns to the first disk, extends through another one of the first linear grooves which remains empty, loops over the first end portion of the spindle, and further extends through yet another one of the first linear grooves which remains empty;
(E) repeating the steps (C) and (D) until the curable fabric material is disposed in all of the first linear grooves and all of the second linear grooves;
(F) cutting the curable fabric material at positions between the first linear grooves and corresponding ones of the second linear grooves so that parts of the curable fabric material, which are located on the first disk, form one of the spoke units independently from parts of the curable fabric material which are located on the second disk and which form the other one of the spoke units after the curable fabric material is cured to produce the semi-product.

According to another aspect of the disclosure, a method for producing a hub assembly is provided. The hub assembly includes a semi-product that includes two spoke units, each of which has a spoke center part and a plurality of spokes radially extending from the spoke center part, two bearings, and a hub axle. The method includes the steps of:
(A) preparing a mold, a curable fabric material that is cord-like, and a central auxiliary curable fabric material, the mold including a first disk, a second disk, and a spindle that connects the center of the first disk and the center of the second disk, the first disk having a plurality of first linear grooves, each of which extends radially from the center of the first disk to the outer periphery of the first disk, the second disk having a plurality of second linear grooves, each of which extends radially from the center of the second disk to the outer periphery of the second disk, and each of which is aligned with a respective one of the first linear grooves, the spindle having a first end portion that protrudes from the first disk, and a second end portion that is located opposite to the first end portion and that protrudes from the second disk;
(B) disposing the curable fabric material such that one end of the curable fabric material is connected to the first end portion of the spindle, such that the curable fabric material loops around the first end portion of the spindle, and such that the curable fabric material extends through one of the first linear grooves;
(C) disposing the curable fabric material on the second disk from the first disk such that the curable fabric material extends through one of the second linear grooves from the one of the first linear grooves, loops over the second end portion of the spindle, and further extends through another one of the second linear grooves which remains empty;
(D) disposing the curable fabric material such that the curable fabric material returns to the first disk, extends through another one of the first linear grooves which remains empty, loops over the first end portion of the spindle, and further extends through yet another one of the first linear grooves which remains empty;
(E) repeating the steps (C) and (D) until the curable fabric material is disposed in all of the first linear grooves and all of the second linear grooves;
(F) cutting the curable fabric material at positions between the first linear grooves and corresponding ones of the second linear grooves so that parts of the curable fabric material, which are located on the first disk, form one of the spoke units independently from parts of the curable fabric material which are located on the second disk and which form the other one of the spoke units after the curable fabric material is cured, the curable fabric material forming two bearing mounting holes of the spoke units at positions where the curable fabric material loops around the first end portion and second end portion after being subjected to curing;
(G) disposing the central auxiliary curable fabric material around the center of the first disk and around the center of the second disk, the central auxiliary curable fabric material forming the spoke center parts of the spoke units which respectively have annular grooves after being subjected to curing;
(H) mounting the bearings into the two bearing mounting holes of the spoke units, respectively, and mounting the hub axle into the annular grooves of the spoke center parts of the spoke units to interconnect the spoke units, so as to produce the hub assembly.

According to still another aspect of the disclosure, a mold which is adapted for forming a curable fabric material into a unitary spoke unit is provided. The mold includes a first disk, a second disk, and a spindle. The first disk has a plurality of first linear grooves, each of which extends radially from the center of the first disk to the outer periphery of the first disk for allowing the curable fabric material to extend therethrough. The second disk has a plurality of second linear grooves, each of which extends radially from the center of the second disk to the outer periphery of the second disk for allowing the curable fabric material to extend therethrough, and each of which is aligned with a respective one of the first linear grooves. The spindle connects the center of the first disk and the center of the second disk, and has a first end portion that protrudes from the first disk for allowing the curable fabric material to loop therearound, and a second end portion that is located opposite to the first end portion and that protrudes from the second disk for allowing the curable fabric material to loop therearound.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of a mold used in an embodiment of a method for producing a hub assembly according to the disclosure.

FIGS. 2 to 12 illustrate successive steps of the embodiment of the method.

FIG. 13 is a fragmentary side view of the mold.

FIG. 14 is a plane view of a semi-product for making a hub assembly produced according to the embodiment of the method.

FIG. 15 is a fragmentary side view of the mold, showing that two lateral auxiliary curable fabric materials connect cut ends of a curable fabric material.

FIG. 16 is a fragmentary sectional view illustrating a central auxiliary curable fabric material being formed in the mold according to another embodiment of the method.

FIG. 17 is a plane view of a semi-product for making a hub assembly produced according to the another embodiment of the method.

FIG. 18 is a fragmentary sectional view of the hub assembly produced by an embodiment of a method for producing a hub assembly according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

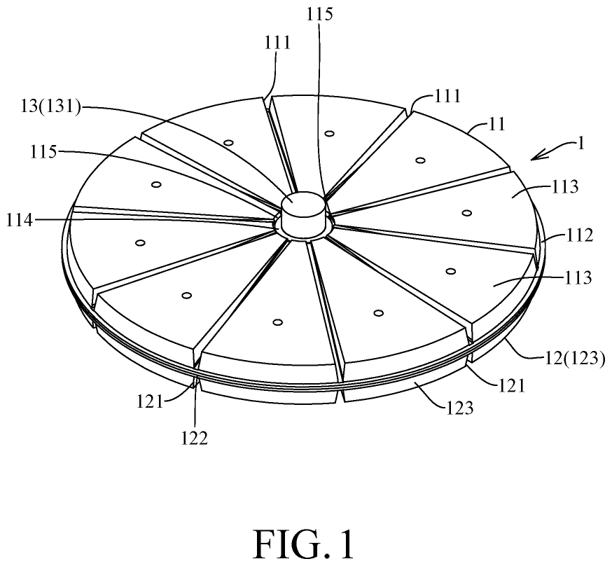

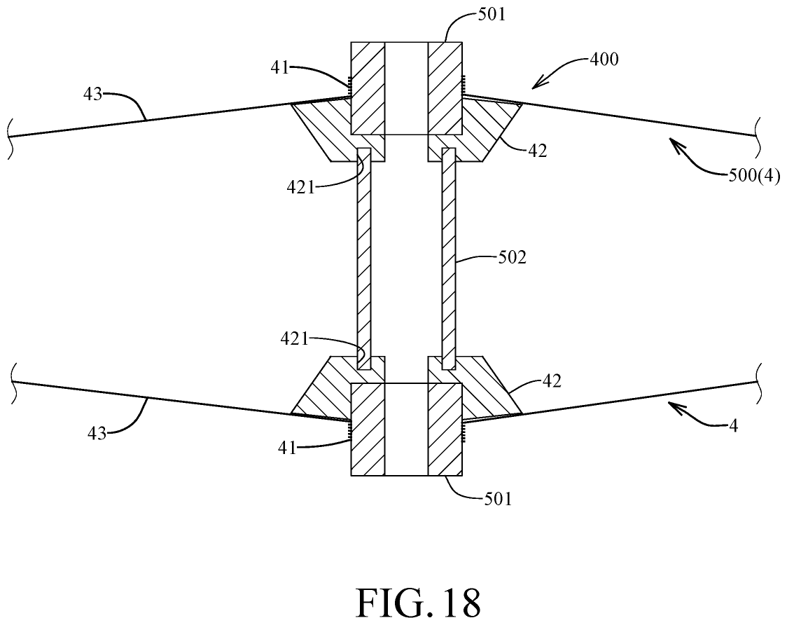

Referring to FIGS. 1 to 14, an embodiment of a method for producing a hub assembly 400 according to the disclosure is shown. Further referring to FIG. 18, in this embodiment, the hub assembly 400 includes a semi-product 500 (semi-finished product), two bearings 501, and a hub axle 502. The semi-product 500 includes two spoke units 4. Each of the spoke units 4 is a unitary spoke unit which has a spoke center part 42 defining a bearing mounting hole 41 for mounting a respective one of the bearings 501, and a plurality of spokes 43 radially extending from the spoke center part 42. The spoke center part 42 of each of the spoke units 4 has an annular groove 421 for connecting the hub axle 502. The method includes steps (A) to (H).

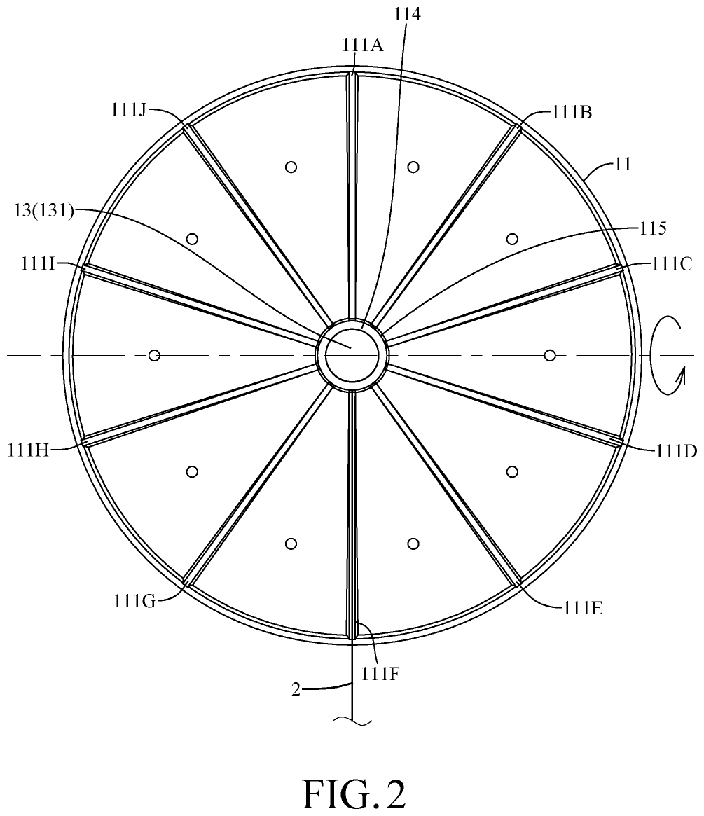

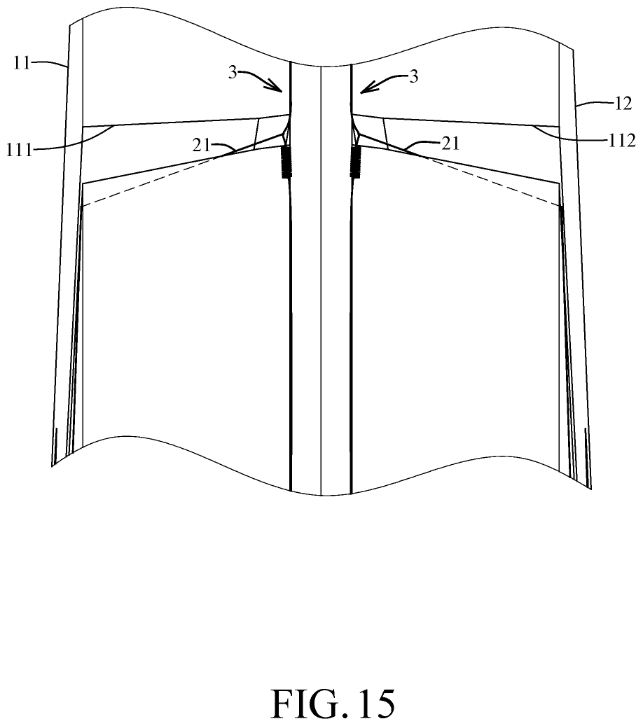

Referring to FIGS. 2, 3, and 18 in combination with FIG. 1, in the step (A), a mold 1, a curable fabric material 2 that is cord-like, two lateral auxiliary curable fabric materials 3 (see FIG. 15), two bearings 501, and a hub axle 502 are prepared.

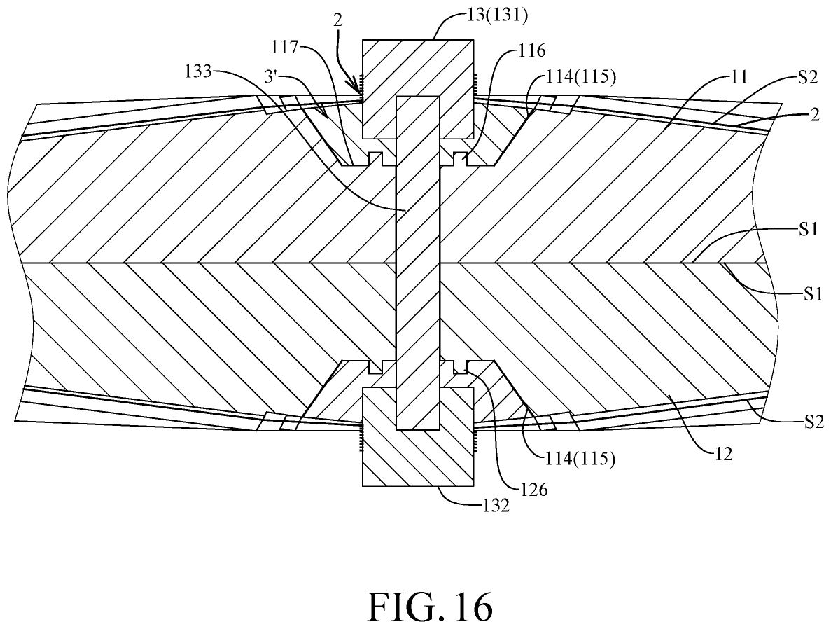

Further referring to FIG. 16, the mold 1 is adapted for forming the curable fabric material 2 into the unitary spoke unit 4, and includes a first disk 11, a second disk 12, and a spindle 13 that connects the center of the first disk 11 and the center of the second disk 12. The first disk 11 has a plurality of first linear grooves 111, each of which extends radially from the center of the first disk 11 to the outer periphery of the first disk 11. The second disk 12 has a plurality of second linear grooves 121, each of which extends radially from the center of the second disk 12 to the outer periphery of the second disk 12, and each of which is aligned with a respective one of the first linear grooves 111. The spindle 13 has a first end portion 131 that protrudes from the first disk 11, a second end portion 132 that is located opposite to the first end portion 131 and that protrudes from the second disk 12, and an axle portion 133 that interconnects the first and second end portions 131, 132. The first and second end portions 131, 132 are removably connected to the axle portion 133.

Specifically, as shown in FIGS. 1 and 16, the first disk 11 includes a first base wall part 112 that forms an inner surface S1 of the first disk 11, a plurality of first block parts 113, each of which protrudes from the first base wall part 112, and each of which forms a part of an outer surface S2 of the first disk 11, a center groove 114 that is indented from the outer surface S2 and that has a groove surrounding wall 115 extending around the first end portion 131 of the spindle 13 in a spaced apart manner, and the first linear grooves 111, each of which is formed between two adjacent ones of the first block parts 113. In other word, the outer surface S2 of the first disk 11 is recessed to form the first linear grooves 111, each of which is located between two adjacent ones of the first block parts 113. Similar to the first disk 11, the second disk 12 includes a second base wall part 122 that forms an inner surface S1 of the second disk 12 that faces toward the inner surface S1 of the first disk 11, a plurality of second block parts 123, each of which protrudes from the second base wall part 122, and each of which forms a part of an outer surface S2 of the second disk 12 that faces away from the outer surface S2 of the first disk 11, a center groove 114 that is indented from the outer surface S2 of the second disk 12 and that has a groove surrounding wall 115 extending around the second end portion 132 of the spindle 13 in a spaced apart manner, and the second linear grooves 121, each of which is formed between two adjacent ones of the second block parts 123. In other words, the outer surface S2 of the second disk 12 is recessed to form the second linear grooves 121, each of which is located between two adjacent ones of the second block parts 123. Each of the first block parts 113 and a respective one of the second block parts 123 are corresponding in position with each other, and have holes aligned with each other for allowing a fastener member to extend therethrough, thereby connecting the first and second disks 11, 12.

In this embodiment, the first disk 11 has N of the first linear grooves 111, and the second disk 12 has N of the second linear grooves 121, where N=10. In other embodiments, N may be an integer other than 10, such as 8, 9, 12, 14, 16, 18, and 20. Besides, in this embodiment, the first linear grooves 111 are equiangularly spaced apart from each other around the center of the first disk 11, and the second linear grooves 121 are equiangularly spaced apart from each other around the center of the second disk 12. Accordingly, in this embodiment, each angle between adjacent ones of the first linear grooves 111 or adjacent ones of the second linear grooves 121 is 36 degrees (i.e. 360/N (N=10)).

The first and second end portions 131, 132 of the spindle 13 protrude respectively and outwardly from the outer surfaces S2 and at the centers of the first and second disks 11, 12.

The curable fabric material 2 and the lateral auxiliary curable fabric materials 3 include fibers such as glass fibers, carbon fibers, and aramid fibers, and are impregnated with curable resin to be formed into curable resin-fiber composites.

Referring to FIG. 2, in the step (B), the curable fabric material 2 is disposed on the first disk 11 such that one end of the curable fabric material 2 is connected to the first end portion 131 of the spindle 13, such that the curable fabric material 2 loops around the first end portion 131 of the spindle 13, and such that the curable fabric material 2 extends through one of the first linear grooves 111.

Specifically, in the step (B), the curable fabric material 2 loops around the first end portion 131 of the spindle 13 to make one complete loop (360 degrees).

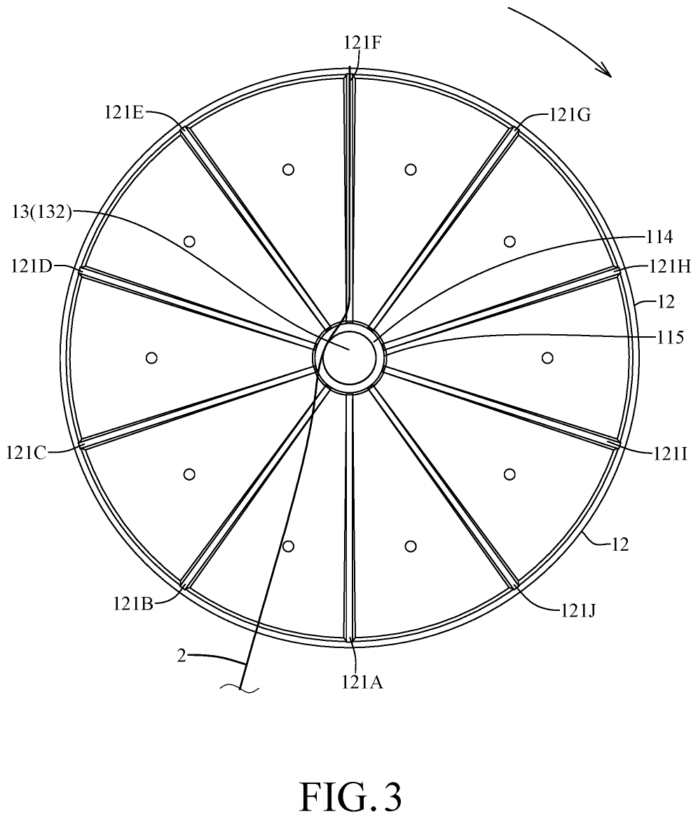

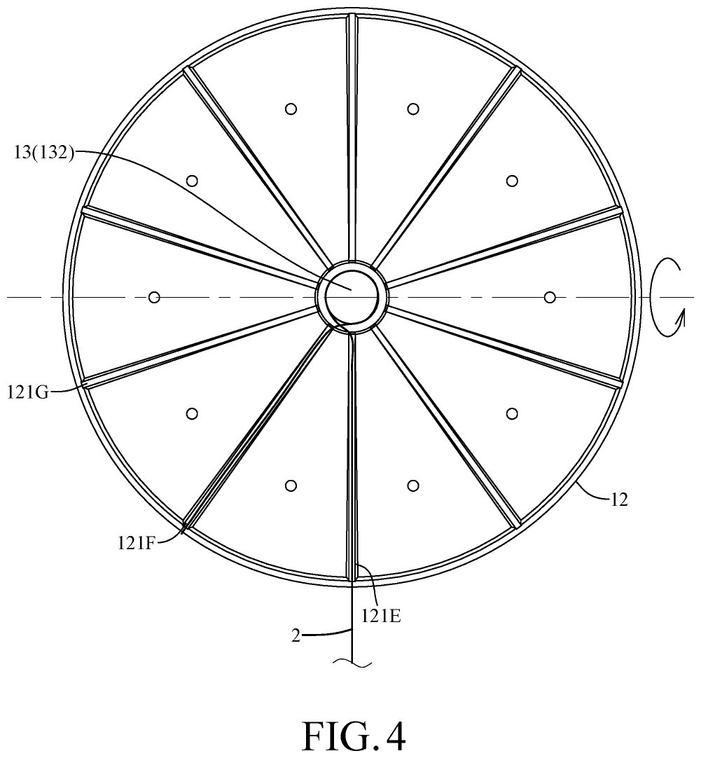

Referring to FIGS. 3 and 4, in the step (C), the curable fabric material 2 is caused to extend to the second disk 12 from the first disk 11 such that the curable fabric material 2 extends through one of the second linear grooves 121 from the one of the first linear grooves 111, to loop over the second end portion 132 of the spindle 13, and to further extend through another one of the second linear grooves 121 which remains empty.

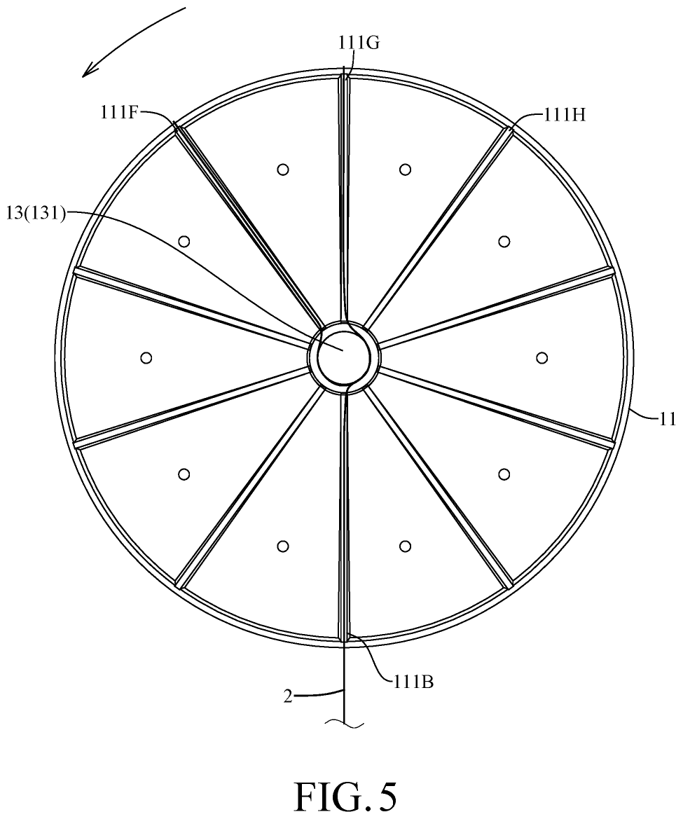

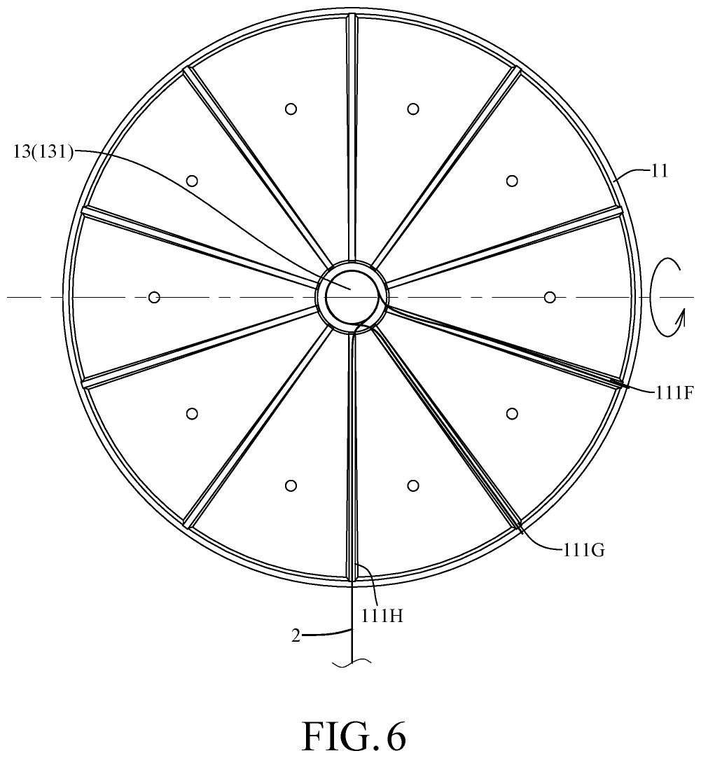

Referring to FIGS. 5 and 6, in the step (D), the curable fabric material 2 is disposed such that the fabric material 2 returns to the first disk 11, extends through another one of the first linear grooves 111 which remains empty, loops over the first end portion 131 of the spindle 13, and further extends through yet another one of the first linear grooves 111 which remains empty.

Specifically, in the step (C), the one of the second linear grooves 121 and the another one of the second linear grooves 121 are two adjacent ones of the second linear grooves 121, and in the step (D), the one of the first linear grooves 111 and the another one of the first linear grooves 111 are two adjacent ones of the first linear grooves 111. Besides, the curable fabric material 2 is disposed such that a part of the curable fabric material 2 that extends from one of the second linear grooves 112 to the second end portion 132 of the spindle 13 intersects with a part of the curable fabric material 2 that extends to the other one of the second linear grooves 112 from the second end portion 132 of the spindle 13. In the step (D), the curable fabric material 2 is disposed such that a part of the curable fabric material 2 that extends from one of the first linear grooves 111 to the first end portion 131 of the spindle 13 intersects with a part of the curable fabric material 2 that extends to the other one of the first linear grooves 111 from the first end portion 131. By virtue of the curable fabric material 2 that forms intersected parts after looping around the first and second end portions 131, 132, the structure formed by the curable fabric material 2 on the mold 1 will be symmetrical so as to facilitate dispersion of stress, and the structure will have a simple and neat appearance.

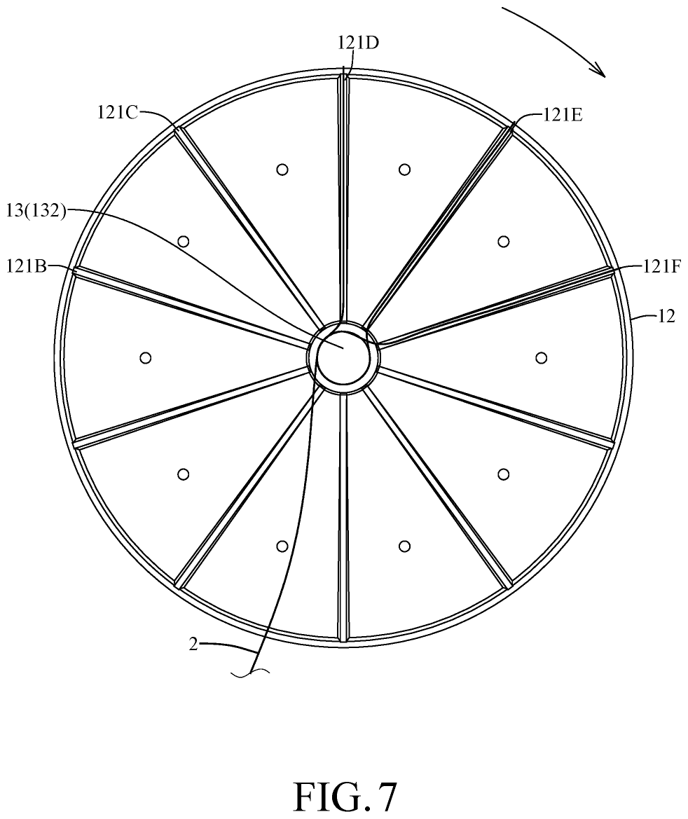

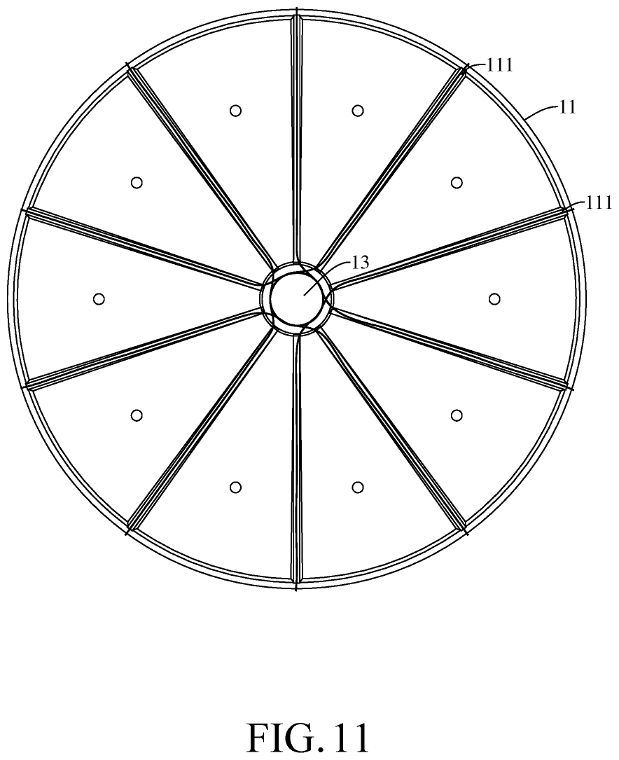

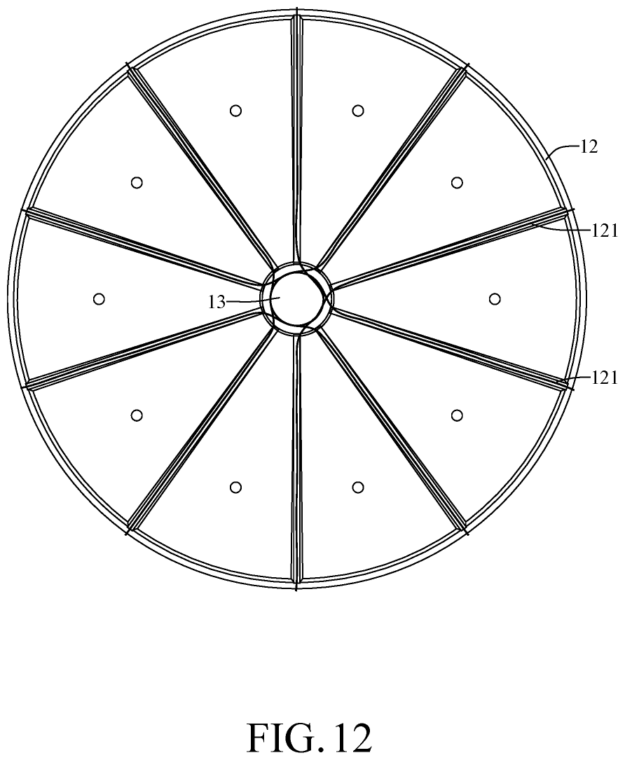

Referring to FIGS. 7 to 10, in the step (E), the steps (C) and (D) are repeated until the curable fabric material 2 is disposed in all of the first linear grooves 111 and all of the second linear grooves 121 (as shown in FIGS. 11 and 12).

In this embodiment, the steps (B) to (E) are implemented by alternately rotating and turning over the mold 1 with an apparatus (not shown) to dispose the curable fabric material 2 on the first disk 11 such that the curable fabric material 2 loops around the first and second end portions 131, 132 of the spindle 13 and extends through all of the first linear grooves 111 and all of the second linear grooves 121. For the sake of simplicity of description, in the following description and the figures, the first linear grooves 111 may be numbered as 111A to 111J in clockwise order from the upper most one of the first linear grooves 111 in FIG. 2, and similarly, the second linear grooves 121 may be numbered as 121A to 121J in clockwise order from the bottommost one of the second linear grooves 121 in FIG. 3. Table 1 is a correspondence table of the first linear grooves 111A to 111J and the second linear grooves 121A to 121J. The table presents the first and second linear grooves 111, 112 listed in each row of the table as if they are aligned with each other. Particularly, the second linear grooves 121A to 121J (see FIG. 3) listed in the right side column of the table are respectively aligned just behind the first linear grooves 111A to 111J (see FIG. 2) listed in the left side column of the table.

TABLE 1

| | |
|---|---|
| the first linear groove 111A | the second linear groove 121A |
| the first linear groove 111B | the second linear groove 121J |
| the first linear groove 111C | the second linear groove 121I |
| the first linear groove 111D | the second linear groove 121H |
| the first linear groove 111E | the second linear groove 121G |
| the first linear groove 111F | the second linear groove 121F |
| the first linear groove 111G | the second linear groove 121E |
| the first linear groove 111H | the second linear groove 121D |
| the first linear groove 111I | the second linear groove 121C |
| the first linear groove 111J | the second linear groove 121B |

Specifically, referring to FIGS. 1 and 2, in the step (B), the mold 1 is in a first position (i.e., the first disk 11 is above the second disk 12). After one end of the curable fabric material 2 is connected to the first end portion 131 of the spindle 13, the mold 1 is rotated about the axis of the spindle 13 such that the curable fabric material 2 loops around the first end portion 131 of the spindle 13. Then, the curable fabric material 2 is disposed to extend through the first linear groove 111F.

Referring to FIGS. 3 and 4, in the step (C), the mold 1 is turned over from the first position to an inverted second position in which the positions of the first and second disks 11, 12 are exchanged with each other such that the curable fabric material 2 is caused to extend through the second linear groove 121F from the first linear groove 111F. Then, the mold 1 is rotated about the axis of the spindle 13 in a clockwise direction such that the curable fabric material 2 loops over the second end portion 132 of the spindle 13, and further extend through the second linear groove 121E adjacent to the second linear groove 121F. In this embodiment, the angle of the rotation of the mold 1 in the step (C) is, for example, 216 degrees (i.e., 180+360/N (N=10)), so as to cause the curable fabric material 2 to form an intersected part proximal to the second end portion 132 of the spindle 13.

Referring to FIGS. 5 and 6, in the step (D), the mold 1 is turned over again to return to the first position such that the curable fabric material 2 is caused to extend through the first linear groove 111G from the second linear groove 121E. Then, the mold 1 is rotated about the axis of the spindle 13 in an anti-clockwise direction such that the curable fabric material 2 loops over the first end portion 131 of the spindle 13, and further extend through the first linear groove 111H adjacent to the first linear groove 111G. In this embodiment, the angle of the rotation of the mold 1 in the step (D) is, for example, 216 degrees (i.e., 180+360/N (N=10)), so as to cause the curable fabric material 2 to form an intersected part proximal to the first end portion 131 of the spindle 13.

In other embodiments, in the steps (C) and (D), in addition to rotating the mold 1 by the apparatus, a robot arm can be used to operate the curable fabric material 2 to reduce the rotation angle of the mold 1. For example, in the step (C), instead of the 216-degree rotation of the mold 1, the mold 1 may be rotated only 36 degrees, followed by operating the curable fabric material 2 with the robot arm so that the curable fabric material 2 loops over the second end portion 132 in a half circle (180 degrees) which causes the curable fabric material 2 to be disposed in the two adjacent ones of the second linear grooves 121 (i.e., the second linear grooves 121E and 121F) and to form the intersected part.

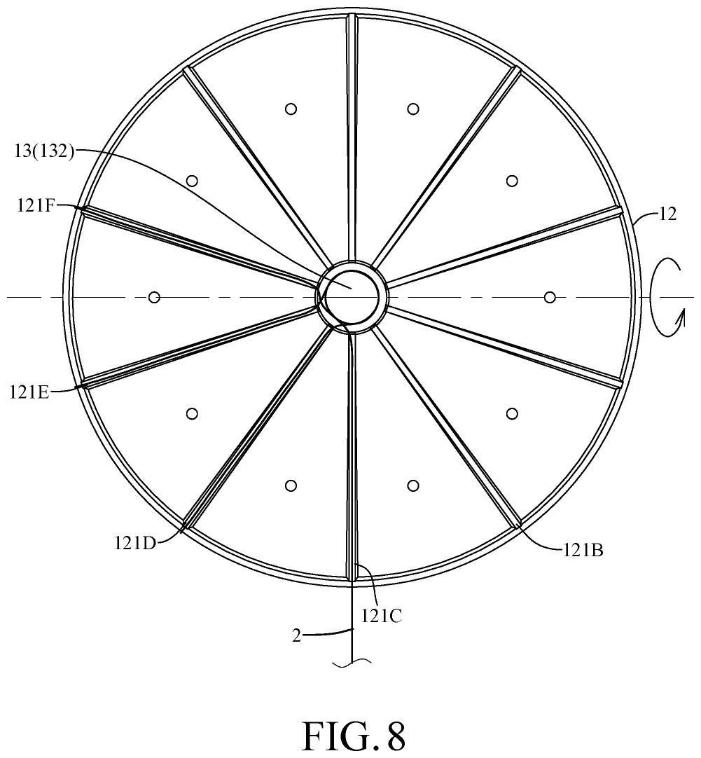

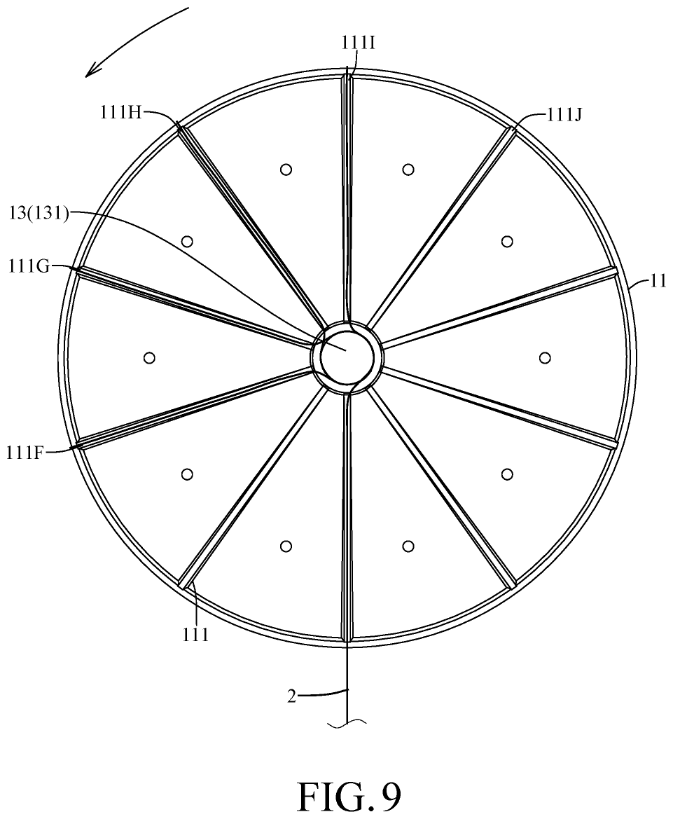

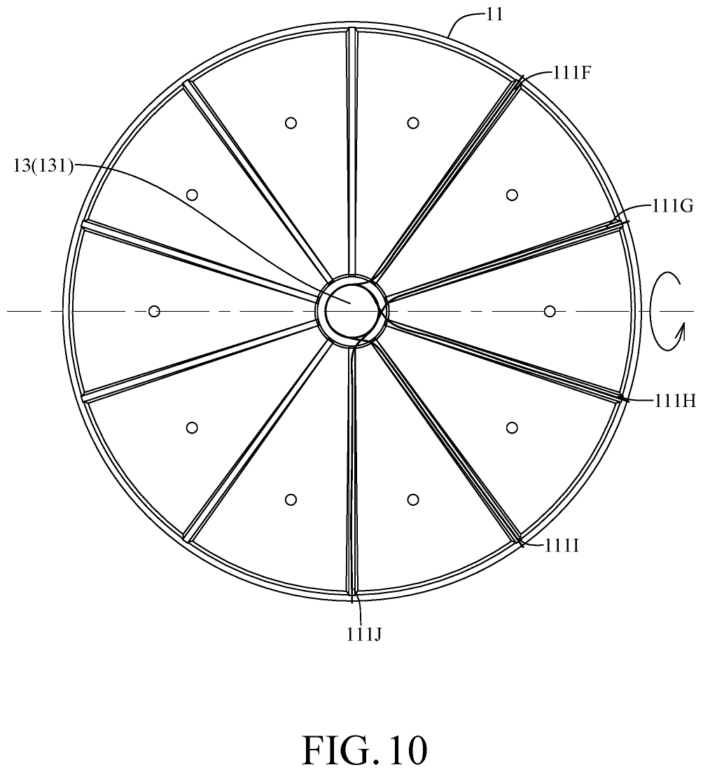

Referring to FIGS. 7 to 10, in the step (E), the steps (C) and (D) are repeated such that the curable fabric material 2 is sequentially disposed in other first and second linear grooves 111, 121 which remain empty. To be specific, in the step (E), the curable fabric material 2 is disposed to extend sequentially through the second linear groove 121D from the first linear groove 111H (see FIG. 7 and the table 1), the second linear groove 121C adjacent to the second linear groove 121D (see FIG. 8), the first linear groove 111I from the second linear groove 121C (see FIG. 9), and the first linear groove 111J adjacent to the first linear groove 111I (see FIG. 10).

It should be noted that, in the description above, the mold 1 is rotated in a clockwise direction in the step (C) and is rotated in an anti-clockwise direction in the step (D); however, the rotation directions of the mold 1 in the steps (C) and (D) are reversible in other embodiments.

The step (E) is performed until the curable fabric material 2 is disposed in all of the first linear grooves 111 (i.e., 111A to 111J) and all of the second linear grooves 121 (i.e., 121A to 121J).

As stated above, in the steps (B) to (E), by repeatedly rotating and turning the mold 1, the curable fabric material 2 is sequentially disposed to extend through the first linear grooves 111 and the second linear grooves 121 until the curable fabric material 2 is disposed in all of the first linear grooves 111 and all of the second linear grooves 121 at the end of the step (E) as shown in FIGS. 11 and 12. However, such implementation of the steps (B) to (E) is merely one embodiment of the disclosure, and in other embodiments, the steps (B) to (E) can be implemented by using some apparatus such as robot arms instead of a rotation apparatus for the mold 1, and also can be implemented by utilizing a combination of robot arms and a rotation apparatus for the mold 1.

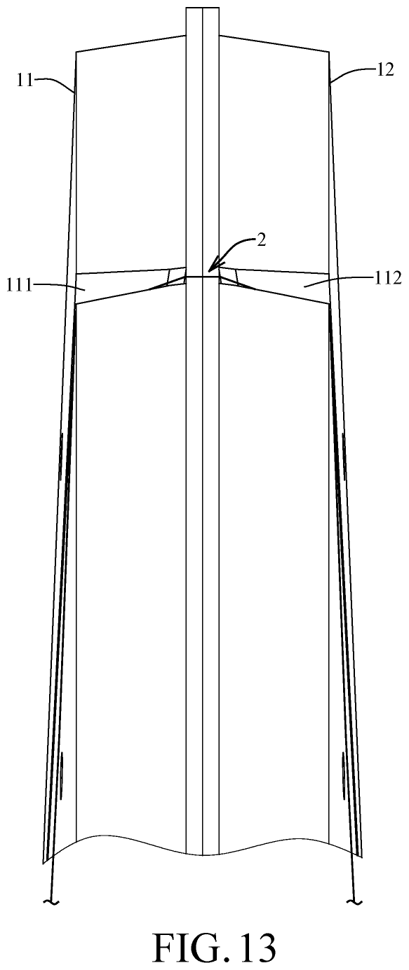

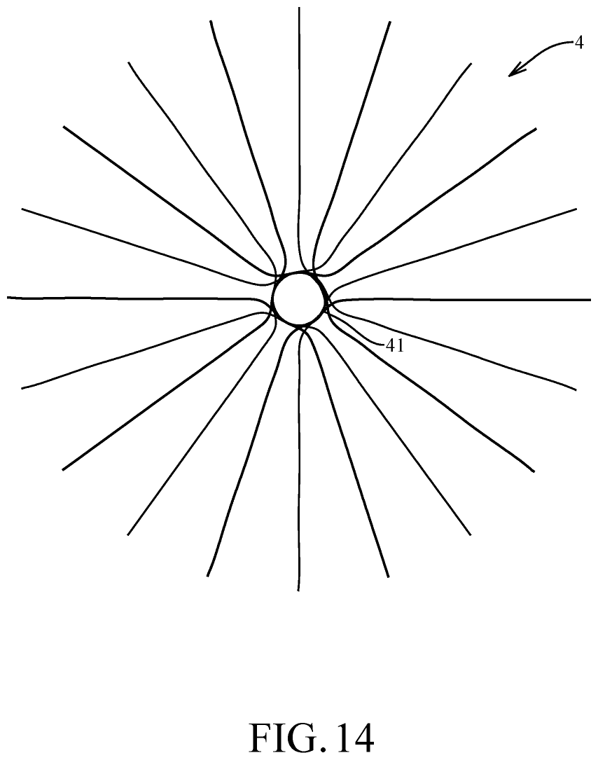

Referring to FIGS. 13 and 14, in the step (F), the curable fabric material 2 is cut along the outer periphery of one of the first and second disks 11, 12 at positions between the first linear grooves 111 and corresponding ones of the second linear grooves 121 so that, after the curable fabric material 2 is cured, parts of the curable fabric material 2, which are located on the first disk 11, form one of the spoke units 4 independently from parts of the curable fabric material 2 which are located on the second disk 12 and which form the other one of the spoke units 4 to produce the semi-product 500 of the hub assembly 400. The curable fabric material 2 forms the bearing mounting holes 41 of the spoke units 4 at positions where the curable fabric material 2 loops around the first and second end portions 131, 132 after being subjected to curing. To be more specific, after the curable fabric material 2 is cured, parts of the curable fabric material 2 which are disposed around the first and second end portion 131, 132 of the spindle 13 form the spoke center parts 42 which define the bearing mounting holes 41, and parts of the curable fabric material 2 which are disposed in the first and second linear grooves 111, 121 form the spokes 43, respectively. Each of the spoke units 4 produced by this embodiment of the method as shown in FIG. 4 may be connected to a rim (not shown) to form a wheel.

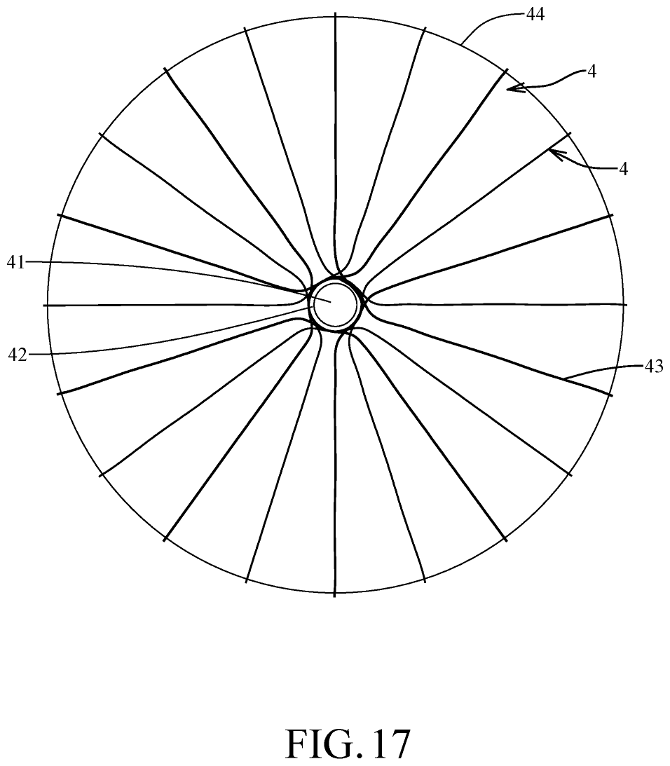

Referring to FIGS. 13, 15, and 16, in another embodiment of the method, each of the spoke units 4 produced thereby further has an annular rim member 44 (see FIG. 17) that is radially spaced apart from the spoke center part 42 and that connects the spokes 43. Compared to the previous embodiment, this embodiment additionally utilizes the lateral auxiliary curable fabric materials 3 to form the annular rim members 44 of the spoke units 4. Particularly, in the step (F), the curable fabric material 2 is cut along the periphery of the first or second disk 11, 12 at positions between the first linear grooves 111 and corresponding ones of the second linear grooves 121 so that parts of the curable fabric material 2, which are located on the first disk 11, form a segmented set 21 of the curable fabric material 2 that forms one of the spoke units 4 independently from parts of the curable fabric material 2, which are located on the second disk 12, form another segmented set 21 of the curable fabric material 2 which form the other one of the spoke units 4 after the curable fabric material 2 is cured. After the curable fabric material 2 is cut at the positions between the first linear grooves 111 and corresponding ones of the second linear grooves 121, the lateral auxiliary curable fabric materials 3 are respectively disposed on the peripheries of the first and second disks 11, 12 such that one of the lateral auxiliary curable fabric materials 3 connects cut ends of the curable fabric material 2 (the segmented set 21) disposed in the first disk 11, and the other one of the lateral auxiliary curable fabric materials 3 connects cut ends of the curable fabric material 2 (the segmented set 21) disposed in the second disk 12, thereby positioning the curable fabric material 2 in the first and second linear grooves 111, 121. Each of the lateral auxiliary curable fabric materials 3 forms the annular rim member 44 of each of the spoke units 4 after the lateral auxiliary curable fabric materials 3 are cured. Specifically, one of the lateral auxiliary curable fabric materials 3 is disposed along the outer periphery of the first base wall part 112 of the first disk 11 to form a closed loop, and the other one of the lateral auxiliary curable fabric materials 3 is disposed along the outer periphery of the second base wall part 122 of the second disk 12 to form a closed loop, so that the annular rim member 44 of each of the spoke units 4 that is formed by a respective one of the lateral auxiliary curable fabric materials 3 is formed into a ring shape. By virtue of the lateral auxiliary curable fabric materials 3, the curable fabric material 2 is positioned in the first and second linear grooves 111, 121 after cutting thereof, thereby improving quality of the semi-product 500.

This embodiment may also be implemented by additionally using a central auxiliary curable fabric material 3′. In an example, the central auxiliary curable fabric material 3′ is further prepared in step (A), and in an additional step (G), the central auxiliary curable fabric material 3′ (see FIG. 16) is disposed around the center of the first disk 11 and around the center of the second disk 12 to respectively form the spoke center parts 42 of the spoke units 4, each having the annular groove 421 after the central auxiliary curable fabric material 3′ is cured. To this end, the center groove 114 of each of the first and second disks 11, 12 is adapted to receive the central auxiliary curable fabric material 3′ for forming the spoke center part 42 of each spoke unit 4. Specifically, as shown in FIG. 16, the center groove 114 of each of the first and second disks 11, 12 has a groove floor 117 that connects one end of the groove surrounding wall 115 at the depth of the center groove 114 and that has an annular rib 116 that protrudes outwardly therefrom around the spindle 13 for forming the annular groove 421 in the spoke center part 42 of each spoke 4.

It is worth mentioning that the curable fabric material 2 and the lateral auxiliary curable fabric materials 3 may be pre-impregnated with resin in step (A). However, the curable fabric material 2 and the lateral auxiliary curable fabric materials 3 may also be fabric materials which have not been impregnated with resin in step (A), but are impregnated with resin in the step (G).

Each of the spoke units 4 of the semi-product 500 thus produced has the bearing mounting hole 41, which is formed, after the curable fabric material 2 is cured, by looping the curable fabric material 2 around the first and second end portions 131, 132 of the spindle 13.

In the step (H), the bearings 501 are mounted into the two bearing mounting holes 41 of the spoke units 4, respectively, and the hub axle 502 is mounted into the annular grooves 421 of the spoke center parts 42 of the spoke units 4 to interconnect the spoke units 4, so as to produce the hub assembly 400.

It is noticed that the outer diameters of the first and second end portions 131, 132 of the spindle 13 may be particularly designed to provide the bearing mounting holes 41 with a proper diameter for mounting the bearings 501, respectively.

When unmolding the spoke units 4 from the mold 1, the first and second end portions 131, 132 are removed from the axle portion 133, and the first and second disks 11, 12 are removed from the spindle 13. Further, after the spoke units 4 are unmolded, the bearing mounting holes 41 of the spoke units 4 are aligned with each other for mounting the hub axle 502 thereinto. After the spoke units 4 are interconnected by the hub axle 502, one of the spoke units 4 may be rotated such that the spokes 43 of one of the spoke units 4 alternate with the spokes 43 of the other one of the spoke units 4 (see FIG. 14). Thus, the hub assembly 400 is produced.

In summary, by virtue of the method for producing the hub assembly 400 according to the disclosure, the unitary spoke unit 4 can be produced through repetitive steps without manual assembly of the spokes 4, thereby reducing manufacturing time of the hub assembly and achieving automation of the manufacturing process of the hub assembly. In addition, by virtue of the mold 1, the curable fabric material 2 can be molded to simultaneously produce two unitary spoke units 4 of the semi-product 500 for making the hub assembly 400. In light of this, the object of the disclosure can be successfully accomplished.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for producing a semi-product for making a hub assembly, the semi-product including two spoke units, each of which has a spoke center part defining a bearing mounting hole for mounting a bearing, and a plurality of spokes radially extending from the center part, the spoke center part having an annular groove for connecting a hub axle, said method comprising the steps of:
(A) preparing a mold and a curable fabric material that is cord-like, said mold including a first disk, a second disk, and a spindle that connects the center of said first disk and the center of said second disk, said first disk having a plurality of first linear grooves each of which extends radially from the center of said first disk to the outer periphery of said first disk, said second disk having a plurality of second linear grooves, each of which extends radially from the center of said second disk to the outer periphery of said second disk, and each of which is aligned with one of said first linear grooves, said spindle having a first end portion that protrudes from said first disk, and a second end portion that is located opposite to said first end portion and that protrudes from said second disk;
(B) disposing said curable fabric material on said first disk such that one end of said curable fabric material is connected to said first end portion of said spindle, such that said curable fabric material loops around said first end portion of said spindle, and such that said curable fabric material extends through one of said first linear grooves;
(C) disposing said curable fabric material on said second disk from said first disk such that said curable fabric material extends through one of said second linear grooves from said one of said first linear grooves, loops over said second end portion of said spindle, and further extends through another one of said second linear grooves which remains empty;
(D) disposing said curable fabric material such that said curable fabric material returns to said first disk, extends through another one of said first linear grooves which remains empty, loops over said first end portion of said spindle, and further extends through yet another one of said first linear grooves which remains empty;
(E) repeating the steps (C) and (D) until said curable fabric material is disposed in all of said first linear grooves and all of said second linear grooves; and
(F) cutting said curable fabric material at positions between said first linear grooves and corresponding ones of said second linear grooves so that parts of said curable fabric material, which are located on said first disk, form one of the spoke units independently from parts of said curable fabric material which are located on said second disk and which form the other one of the spoke units after said curable fabric material is cured to produce the semi-product.

2. The method as claimed in claim 1, wherein said first linear grooves are equiangularly spaced apart from each other around the center of said first disk, and said second linear grooves are equiangularly spaced apart from each other around the center of said second disk.

3. The method as claimed in claim 2, wherein in the step (C), said one of said second linear grooves and said another one of said second linear grooves are two adjacent ones of said second linear grooves, and wherein in the step (D), said one of said first linear grooves and said another one of said first linear grooves are two adjacent ones of said first linear grooves.

4. The method as claimed in claim 3, wherein in the step (C), said curable fabric material is disposed such that a part of said curable fabric material that extends from said one of said second linear grooves to said second end portion intersects with a part of said curable fabric material that extends to said another one of said second linear grooves from said second end portion, and wherein in the step (D), said curable fabric material is disposed such that a part of said curable fabric material that extends from said another one of said first linear grooves to said first end portion intersects with a part of said curable fabric material that extends to said yet another one of said first linear grooves from said first end portion.

5. The method as claimed in claim 1, wherein:
in the step (A), two lateral auxiliary curable fabric materials are further prepared;
in the step (F), after said curable fabric material is cut at positions between said first linear grooves and corresponding ones of said second linear grooves, said lateral auxiliary curable fabric materials are respectively disposed on the peripheries of said first disk and said second disk such that one of said lateral auxiliary curable fabric materials connects cut ends of said curable fabric material disposed in said first disk, and the other one of said lateral auxiliary curable fabric materials connects cut ends of said curable fabric material disposed in said second disk.

6. The method as claimed in claim 1, wherein:
after said curable fabric material is cured, said curable fabric material forms said bearing mounting hole of one of said spoke units where said curable fabric material loops around said first end portion of said spindle and forms said bearing mounting hole of the other one of said spoke units where said curable fabric material loops around said second end portion of said spindle;
in the step (A), a central auxiliary curable fabric material is further prepared; and
said method further comprising step (G): disposing said central auxiliary curable fabric material around the center of said first disk and around the center of said second disk to respectively form the spoke center parts of said spoke units each having said annular groove after said central auxiliary curable fabric material is cured.

7. A method for producing a hub assembly, the hub assembly including a semi-product that includes two spoke units, each of which has a spoke center part and a plurality of spokes radially extending from said spoke center part, two bearings, and a hub axle, said method comprising the steps of:
(A) preparing a mold, a curable fabric material that is cord-like, and a central auxiliary curable fabric material, said mold including a first disk, a second disk, and a spindle that connects the center of said first disk and the center of said second disk, said first disk having a plurality of first linear grooves, each of which extends radially from the center of said first disk to the outer periphery of said first disk, said second disk having a plurality of second linear grooves, each of which extends radially from the center of said second disk to the outer periphery of said second disk, and each of which is aligned with a respective one of said first linear grooves, said spindle having a first end portion that protrudes from said first disk, and a second end portion that is located opposite to said first end portion and that protrudes from said second disk;
(B) disposing said curable fabric material such that one end of said curable fabric material is connected to said first end portion of said spindle, such that said curable fabric material loops around said first end portion of said spindle, and such that said curable fabric material extends through one of said first linear grooves;
(C) disposing said curable fabric material on said second disk from said first disk such that said curable fabric material extends through one of said second linear grooves from said one of said first linear grooves, loops over said second end portion of said spindle, and further extends through another one of said second linear grooves which remains empty;
(D) disposing said curable fabric material such that said curable fabric material returns to said first disk, extends through another one of said first linear grooves which remains empty, loops over said first end portion of said spindle, and further extends through yet another one of said first linear grooves which remains empty;
(E) repeating the steps (C) and (D) until said curable fabric material is disposed in all of said first linear grooves and all of said second linear grooves;
(F) cutting said curable fabric material at positions between said first linear grooves and corresponding ones of said second linear grooves so that parts of said curable fabric material, which are located on said first disk, form one of the spoke units independently from parts of said curable fabric material which are located on said second disk and which form the other one of said spoke units after said curable fabric material is cured, said curable fabric material forming two bearing mounting holes of the spoke units at positions where said curable fabric material loops around said first end portion and said second end portion after being subjected to curing;
(G) disposing said central auxiliary curable fabric material around the center of said first disk and around the center of said second disk, said central auxiliary curable fabric material forming said spoke center parts of said spoke units which respectively have annular grooves after being subjected to curing; and
(H) mounting said bearings into said two bearing mounting holes of said spoke units, respectively, and mounting said hub axle into said annular grooves of said spoke center parts of said spoke units to interconnect said spoke units, so as to produce said hub assembly.

8. The method as claimed in claim 7, wherein, in the step (H), said spoke units are interconnected such that said spokes of one of said spoke units alternate with said spokes of the other one of said spoke units.

9. A mold which is adapted for forming a curable fabric material into a unitary spoke unit, said mold comprising:
a first disk having a plurality of first linear grooves, each of which extends radially from the center of said first disk to the outer periphery of said first disk for allowing said curable fabric material to extend therethrough;
a second disk having a plurality of second linear grooves, each of which extends radially from the center of said second disk to the outer periphery of said second disk for allowing said curable fabric material to extend therethrough, and each of which is aligned with a respective one of said first linear grooves; and
a spindle connecting the center of said first disk and the center of said second disk, and having a first end portion that protrudes from said first disk for allowing said curable fabric material to loop therearound, and a second end portion that is located opposite to said first end portion and that protrudes from said second disk for allowing said curable fabric material to loop therearound.

10. The mold as claimed in claim 9, wherein
each of said first disk and said second disk has an inner surface and an outer surface, said inner surfaces of said first disk and said second disk facing toward each other, said outer surfaces of said first disk and said second disk facing away from each other and being recessed to form said first linear grooves and said second linear grooves,
said first end portion and said second end portion of said spindle protrude respectively and outwardly from said outer surfaces and at the centers of said first disk and said second disk,
each of said first disk and said second disk further has a center groove that is indented from said outer surface and that has a groove surrounding wall extending around one of said first end portion and said second end portion of said spindle in a spaced apart manner,
said center groove is adapted to receive a central auxiliary curable fabric material for forming a spoke center part of one of said spoke units.

11. The mold as claimed in claim 10, wherein said center groove of each of said first disk and said second disk further has a groove floor that connects one end of said groove surrounding wall at the depth of said center groove and that has an annular rib that protrudes outwardly therefrom around said spindle for forming an annular groove in said spoke center part.
